(19) United States
(12) Patent Application Publication
(10) Pub. No.: US 2005/0114130 A1
(43) Pub. Date: May 26, 2005

(54) Systems and methods for improving feature ranking using phrasal compensation and acronym detection

(75) Inventors: Akshay Java, Baltimore, MD (US); Brian Klock, Hillsborough, NJ (US); Eric J. Glover, North Brunswick, NJ (US); Vishal Shanbhag, Baltimore, MD (US); Robert Krovetz, Plainsboro, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 10/888,419

(22) Filed: Jul. 9, 2004

Related U.S. Application Data
(60) Provisional application No. 60/523,851, filed on Nov. 20, 2003.

(51) Int. Cl. G10L 15/12

(52) U.S. Cl. 704/240

(57) ABSTRACT

Systems and methods are disclosed for analyzing a set of documents by building a positive set histogram; selecting phrases from the positive set histogram; modifying the frequency statistics in the histogram using the selected phrases; identifying one or more potential phrase-acronym pairs; selecting a subset of phrase-acronym pairs from the potential pairs; adding a new feature for each selected phrase-acronym (phrase ∥ acronym) pair to a positive set histogram; determining a value for each new feature; identifying one or more child concepts based on an updated histogram; grouping the one or more child concepts; and determining a child concept group coverage for one or more documents.

This Application claims priority to Provisional Application Ser. No. 60/523,851, filed on Nov. 20, 2003 and entitled “Method and System for Improving Document Relevance Ranking by Discovering General and Specific Documents”, the content of which is incorporated by reference. This application is also related to U.S. Utility patent application, Ser. No. 10/209,594, entitled “INFERRING HIERARCHICAL DESCRIPTIONS OF A SET OF DOCUMENTS”, filed on Mar. 31, 2002, the contents of which are hereby incorporated by reference herein.

### BACKGROUND

The World-Wide-Web (“Web”) has become immensely popular largely due to the ease of distributing information to a large audience. However, with the volume of data available on the Internet increasing at an exponential rate, the effort required to obtain meaningful results on the Internet is also increasing. To help find, locate or navigate information on the Web, tools known as Internet search engines can be used. On the Internet, for example, most search engines provide a keyword search interface to enable their users to quickly scan the vast array of known documents on the Web for documents which are most relevant to the user's interest. Typically, they provide Boolean and other advanced search techniques that work with their private catalog or database of Web sites.

As noted in application Ser. No. 20030120654, examples of search engines include Yahoo (http://www.yahoo.com), Google (www.google.com) and others. Some search engines give special weighting to words or keywords: (i) in the title; (ii) in subject descriptions; (iii) listed in HTML META tags, (iv) in the position first on a page; and (iv) by counting the number of occurrences or recurrences (up to a limit) of a word on a page. In its simplest form, the input to keyword searches in a search engine is a string of text that represents all the keywords separated by spaces. When the “search” button is pressed by the user, the search engine finds all the documents which match all the keywords and returns the total number that match, along with brief summaries of a few such documents.

There have been a number of technologies that have been developed to improve the searching of a corpus of documents and navigating through the results. One useful technique has been the approach of building concept hierarchies, for example using a statistical approach or using a natural language processing-based model. Another well-researched area has been text clustering, in which related documents and/or terms in documents are grouped together using a wide range of algorithms. Most search engines used on the Internet today use ranking strategies that take advantage of relevance functions that can range from the simplistic to the very sophisticated.

Current content-based relevance functions typically consider the individual query keywords (or possibly related words) and their appearance in a target document. Unfortunately, sometimes a document may contain the keywords, but not be meaningfully relevant because it is too specific. For example, a document about “The Architecture of the Sistine Chapel” is statistically relevant to a query of “architecture”, even though it has nothing to do with the more general concept of architecture—instead it is overly specific. A document about “Buildings throughout the ages—An architectural history” is both more general, hence more relevant-even if it contains the word “architecture” fewer times than the document about the Sistine Chapel.

To improve the accuracy of the search engines, a ranked list of features (words or phrases) can be generated from a collection of documents (web or otherwise). Conventional methods use a “bag of words” model to determine the set of possible features. However, when adding phrases to the bag of words model, component words may be double-counted, causing the ranking of the phrases to appear incorrect. For example: a category of documents “martial arts” may be named “arts” or “martial” because those two words are very common, however the correct phrase “martial arts” is a better name for the set than its component terms.

### SUMMARY

In one aspect, systems and methods are disclosed for automatically improving web document ranking and analysis by predicting how ‘general’ a document is with respect to a larger topic area. Systems and methods are disclosed for automatically predicting how “general” a document is with respect to a larger topic area by improving the feature set through modification of feature group statistics; identifying one or more child concepts from the improved feature concept group; grouping the one or more child concepts; and determining the child concept group coverage for each document.

In another aspect, systems and methods are also disclosed for updating histogram statistics of keyword features by building a positive set histogram; selecting phrases from the positive set histogram; and modifying the frequency statistics in the histogram using the selected phrases.

In another aspect, systems and methods are disclosed for updating search features by building a positive set histogram; selecting phrases from the positive set; and updating the counts for the selected phrases in the positive set histogram.

In yet another aspect, the systems and methods updates search features by identifying one or more potential phrase-acronym pairs; selecting a best phrase-acronym pair from the potential pairs; and updating the positive set histogram with the best phrase-acronym pair.

In another aspect, systems and methods are disclosed for analyzing a set of documents by building a positive set histogram; selecting phrases from the positive set histogram; modifying the frequency statistics in the histogram using the selected phrases; identifying one or more potential phrase-acronym pairs; selecting a subset of phrase-acronym pairs from the potential pairs; adding a new feature for each selected phrase-acronym (phrase ∥ acronym) pair to a positive set histogram; determining a value for each new feature; identifying one or more child concepts based on an updated histogram; grouping the one or more child concepts; and determining a child concept group coverage for one or more documents.

Advantages of the system may include one or more of the following. The system improves search and relevance by improving the ability to rank, understand and describe documents or document clusters. The system improves the meaningfulness of features to describe a group of documents (phrasal compensation) and uses the proper features to discover groups of related (compensated) features, and to use these groups to predict documents that, although they may contain a user's query, are not actually relevant. In addition, this method provides information in the form of named concept groups, which facilitates a human deciding which documents to examine. Phrasal compensation (which includes acronym feature addition) allows for improved grouping, more meaningful names, and hence an improved ability to compute negative relevance to select documents that are not relevant. The phrasal compensation provides a simple method to compensate for the statistical errors caused by considering phrases—resulting in improvements in feature ranking. Phrasal compensation can operate in a language independent manner and requires no special knowledge. In addition, it can be done very efficiently without having to re-analyze the collection for each application—even though the important phrases vary between applications.

The system uses a combination of phrases and acronyms to enhance searching. Acronyms are combined with their appropriate phrases to produce a more meaningful name for a cluster. For example, a better name for the “computer science” community should be “computer science OR cs”, however the community “martial arts” should not be called “martial arts OR ma”. Efficiency is enhanced in that the system avoids the need to rescan the entire collection to compensate for phrases or acronyms of a cluster or community of web pages.

The system produces significantly improved results, allowing for superior automatic naming or descriptions of communities. When performing classification, phrasal compensation and acronym detection can be used to improve query expansion, classification, feature selection, feature ranking and other tasks that are fundamental to text-based document analysis. The phrasal compensation system is language independent, so it could be applied to documents in virtually any language. Moreover, the system efficiently predicts appropriate acronym phrase combinations.

The system can automatically predict how “general” a document is with respect to a larger topic area. In addition to locating documents that are “relevant”, it is sometimes desirable to rank known-relevant documents based on how general or specific they are for a given topic. A user who wants to learn about biology might prefer a page with many links and a broad coverage to one with less topic-aligned contents. The methodology disclosed in the present invention can provide a set of what the inventors refer to as “important child concept groups”. These concept groups could be used to improve a search by showing users more meaningful information about the documents and the larger topic.

The system can improve relevance ranking over existing mechanisms. Documents that are statistically relevant can be corrected automatically. Search engines and any information retrieval system can be improved by utilizing the above system. The system can also advantageously aid users in searching by improving how results are presented to the user. Enhancing the concept grouping with acronyms and phrases can aid in presenting a short document overview (of the topic areas covered), as well as ranking documents to maximize the overall value to the user. The extra information can aid the user in formulating new queries and filtering through a smaller set of more relevant results.

### BRIEF DESCRIPTION OF THE DRAWINGS

The invention will be more fully understood from the description of the preferred embodiment with reference to the accompanying drawings, in which:

FIG. 1A-1B show exemplary processes for determining “generality” of documents.

FIG. 2 shows an exemplary process for hierarchical clustering of concept groups.

FIG. 3 shows an exemplary listing of groups and members of each group.

FIG. 4 shows an exemplary process for negative relevance ranking of search results.

FIGS. 5 shows an exemplary process for phrasal compensation.

FIGS. 6A-6B show exemplary processes for generating phrases from a corpus.

FIG. 7 shows an exemplary process for acronym compensation.

### DESCRIPTION

During a search operation, in addition to locating documents that are “relevant”, it is sometimes desirable to rank known-relevant documents based on how general or specific they are for a given topic. A user who wants to learn about biology might prefer a page with many links and a broad coverage to one with less topic-aligned contents. Although “generality” can be a very subjective concept, certain characteristics of documents can help statistically identify how general or specific a given document is. An advantageous definition of generality is as follows. A document can be considered to be “general” if it satisfies the following properties: (1) It covers many of the important sub topics for the given search category; (2) It is not overly focused on only a few of these sub topics; and (3) It has enough information about the topic and doesn't merely mention the topic.

In one embodiment, the system automatically predicts how “general” a document is with respect to a larger topic area. “Important child groups” are used to improve a search by showing users more meaningful information about the documents and the larger topic. In this embodiment of the invention, the search procedure can be divided into a three-step approach, each step providing its own unique advantages, with the combination being the most useful. The process starts with an initial set of “probably” relevant documents. An existing relevance function can be utilized for this.

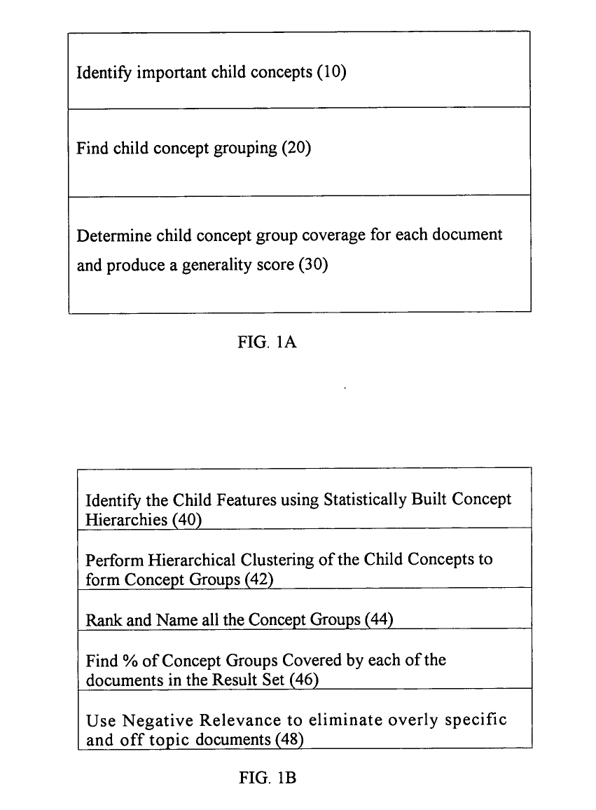

As shown in FIG. 1A:
First, the “important” child concepts are identified (10).
Second, child concept grouping is performed (20).
Third, a determination is made as to the child concept group coverage for each document, and this is utilized to produce a generality score (30).

In a second exemplary embodiment shown in FIG. 1B, the system identifies Child Features using Statistically Built Concept Hierarchies (40); performs Hierarchical Clustering of the Child Concepts to form Concept Groups (42); Ranks and Names the Concept Groups (44); finds the percentage of Concept Groups Covered by each of the documents in the Result Set (46); and uses Negative Relevance to eliminate overly specific and off topic documents (48).

Details of the foregoing operations are described next.

In order to know how “general” a document is, it is advantageous to first identify the “concept groups” associated with the results. In a previous patent filing (Ser. No. 10/209,594, entitled “INFERRING HIERARCHICAL DESCRIPTIONS OF A SET OF DOCUMENTS”, filed on Mar. 31, 2002, the contents of which are hereby incorporated by reference herein), an advantageous method was disclosed for discovering a local topic hierarchy from a set of initial documents, the topic hierarchy containing “parent”, “self’ and “child” concepts. Thus, it is possible to statistically determine the terms used to describe the parents, self and children for a given category. These techniques can be utilized to find the list of features that describe the child terms associated with the given search results.

In choosing the child concepts, the process starts with a “collection histogram”, and then builds a “positive set histogram.” For each feature in the positive set histogram, examine the positive set frequency (percent), and the collection frequency (percent). If the positive set frequency percentage and collection set percentage of a given feature are between predefined ranges, select that feature as a child, otherwise skip. For the present application, a range of (X1, 0)-(X2, Y2) can be used, where the x co-ordinate refers to the positive set frequency, and the y co-ordinate refers to the collection frequency. X1 is the minimum positive set frequency, denoted herein minChildPositive; X2 is the maximum positive set frequency, denoted herein maxChildPositive; and Y2 is the maximum collection frequency, denoted herein maxChildNegative. Once the set of children is obtained, one can further rank these children to determine the likely “best” or “primary” children. This is done by ranking on a function of the positive set frequency and collection frequency. One function can include (Fp*(Fc+e)). Fp refers to the positive set frequency, and Fc is the collection frequency, e is epsilon (a small constant). If the boundaries for selecting the “child” concepts is not known, a static guess value can be used.

The following threshold S used for identifying the child features can be used:
maxChildPositive=0.4
inaxChildNegative=0.01
minChildPositive=0.04

Any term that satisfies the above threshold S can be considered as a child term. For purposes of the preferred embodiment described herein, the self and the parent terms are not considered in identifying generality self terms are not considered since it is desirable to distinguish the documents that merely mention the self concepts and do not cover enough child groups to qualify as a general document.

The above step provides a list of child concepts, although some of these concepts might be similar or related. At times for a given search result there may be a number of child terms present for each of the sub topics. For example, for a query “digital cameras” there are features for different companies, say “Nikon”, “Olympus”, “Cannon” etc. Also in some cases there might be terms that mean the same but are written differently for example “Megapixel”, “Mega Pixel” or “MP”. Considering such child features independently could often be confusing and misleading. Hence a document mentioning “MP” and “Mega Pixel” would count as containing two features, even though they are strongly related. Hence counting related features separately can skew the percentage coverage.

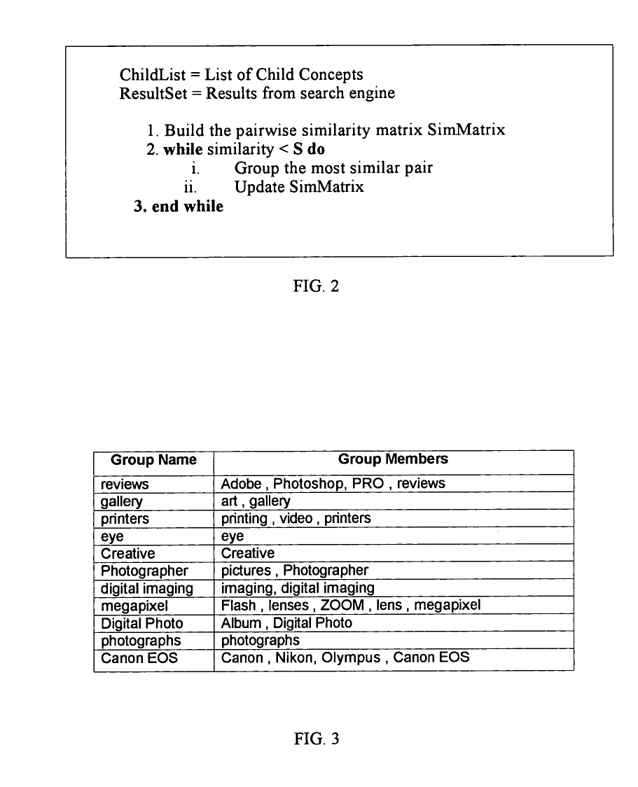

In order to overcome this problem, it is advantageous to automatically discover features that should be grouped together. Child concept grouping is a method for discovering the features that should be grouped together, and can be performed using the method shown in FIG. 2, whose pseudo code is as follows:
ChildList=List of Child Concepts
ResultSet=Results from search engine
   1. Build the pairwise similarity matrix SimMatrix
   2. while similarity>threshold S do
      i. Group the most similar pair
      ii. Update SimMatrix
   3. end while

The methodology shown in FIG. 2 is an agglomerative hierarchical clustering approach. For each feature in the Child List, a determination is made as to its similarity to every other feature based on the document co-occurrence.

The most similar pairs are then grouped until there are no pairs (or groups of features) that have more than some minimum S similarity. For an implementation, threshold S can be between 0.4 and 0.6.

For the SimMatrix computation, one way for identifying term relationships is by using statistical co-occurrence information. Each Child concept present in the result set is associated with a k dimensional vector, where k is the number of documents in the result set. Each element in this vector can be represented by a 1 or 0 indicating the presence or absence of the term in that document. The similarity score between the child concepts can be computed by taking the cosine of the vectors associated with each of the terms. If the score is closer to 1 it indicates that the two words frequently occur together in the same document.

```
If
  X = Boolean vector associated with child concept Ci
  Y = Boolean vector associated with child concept Cj
      Xk =1 if Ci is present in document k
    & Xk =0 if Ci is not present in document k
Cosine similarity (Ci,Cj) = | X intersection Y|/ sqrt(|X| * |Y|)
```

Thus an N*N upper triangular matrix called SimMatrix is constructed, where N=the number of Child concepts present in the result set. Each element in this matrix represents how closely the two terms are related to each other.

Agglomerative clustering technique is used to group the most similar child concepts together. A dimensionally reduced feature set consisting only of the important child concepts is used so that term similarities for large result sets can be determined efficiently. Also, efficiency is enhanced by considering only the child concepts results in clusters that are conceptually more related. The concepts that are related would often co-occur. For example, say that “mp” co-occurs often with “price”, “review” “sensor” jpeg”. The feature “megapixel” also co-occurs with the same features, thus they are considered similar.

The clusters obtained in the previous step can be ranked based on the popularity of its members in both the negative set histogram and the positive set histogram. The following formula can be used to rank the clusters according to the following:

$$GroupRank = \frac{1}{n} {\sum }_{i = 1}^{n} ( {F}_{i}^{+} * ( {F}_{i}^{-} + ɛ ) )$$

where F⁺ is the positive set frequency, F⁻ is the negative set frequency, n is the number of concepts in the group, and epsilon is a constant (typically 0.004). The negative set popularity is used to make the system resistant to some of the statistical biases that may exist in the positive set. Thus terms that are equally popular in the positive set can be ranked by also taking into account their popularity in the negative set. The term that has the highest score based in this ranking function is used to represent the cluster. The assumption here is that the term that best represents the group is the one that is most popular in the overall collection.

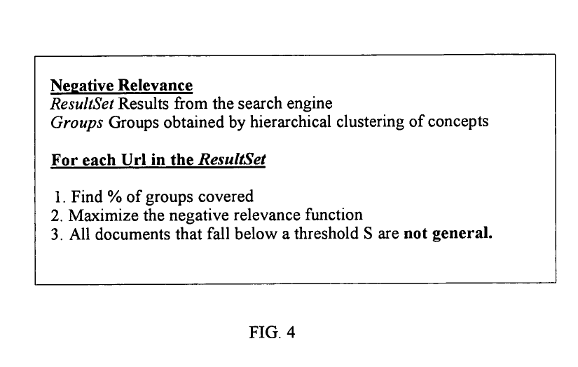

An example of the clustering of the concepts and their group names is shown in FIG. 3 for the illustrative query of “digital photography”.

Since generality is a very subjective concept, it may be difficult to compare and rank the individual documents in the order of generality. Instead, a set that contains the most general documents from the results is generated.

A determination can be made as to the child concept group coverage for each document, and this can be utilized to produce a generality score. The goal is to determine a “generality score” for each document; this is accomplished by identifying the concept groups covered by each document. There are several ways to do this, ranging from the simplistic to the more complicated. A simple methodology is as follows: If any of the keywords from the child-concept-group occur anywhere in a document, that child concept group is considered covered. The total score is the total number of “covered child concept groups”. A better methodology would be as follows: Examine the regions of the document covered by a given child-concept group. Concepts can be given scores based on the amount of coverage, and a document score can consider both. For example a dictionary document contains all “words”, and hence would appear “perfect” by the simple measure. By considering the relative coverage, then the score would be lower, since only a tiny fraction of the dictionary addresses each of the covered concepts.

A new method for improving relevance ranking is disclosed called “negative relevance”, where one removes documents that are either too specific or do not address any of the primary themes of the topic area. Such documents are likely not useful for the purpose of identifying generality. First, all of the documents that are likely relevant (by an existing method) to the query are found and then the results are pruned by eliminating the documents that do not satisfy the negative relevance maximizing function. Thus, the negative relevance technique can be used to retrieve the result set and then a negative scoring function is applied. Any result that doesn't satisfy a minimum cutoff for the negative scoring function can be eliminated from the result set.

In the simplest case the function can aim to select documents that cover the most concept groups, i.e. documents that cover a large number of concept groups qualify as general documents since they talk about most of the sub topics. However, in some cases there might be documents that mention most of the concepts but might be biased towards a specific concept. In order to distinguish such documents we need to introduce partial group membership or need to evaluate them based on the frequency distribution of the terms belonging to each of the concept groups. Documents that are heavily biased towards a few of the child concepts alone are termed to be overly specific and are hence could be eliminated.

A better negative relevance function would be to examine the region of the document covered by a given child-concept group. Concepts can be given scores based on the amount of coverage, and thus partial group memberships can be defined. A document can be said to belong “x % to group A”. This would be beneficial for example in cases where the document contains all the terms but only a small fraction of the document actually talks about the subject.

Thus using negative relevance function, existing ranking schemes can be used and if certain attributes described by the function are covered below a certain threshold the document is defined as “bad”. This is different from the typical “positive relevance functions” where we try to include “good documents”, here the aim is to exclude the “obviously bad documents”.

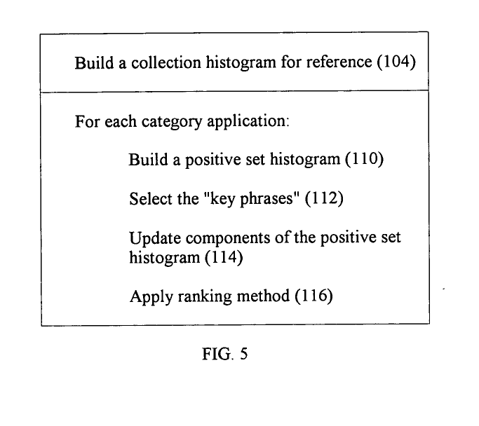

FIG. 4 shows a preferred embodiment using the negative relevance approach as follows:

Negative Relevance
ResultSet Results from a data-source found by using a traditional relevance function
Groups Groups obtained by hierarchical clustering of concepts

For each URL in the ResultSet
1. Find % of groups covered
2. Maximize the negative relevance function
3. All documents that fall below a threshold S are not general.

The end result provides a much smaller set of documents with which one could gather enough information about the topic without having to look through a large number of results. The technique also provides added benefits of identifying the subtopics present in the results and can be applied to any type of collections.

The system can be used to remove “spam” documents or documents that are written to contain many keywords that a user is likely to type in. The present approach considers much more than just the user's query words, thereby making it much more difficult to make a document that will score highly unless the document is actually relevant to the topic area.

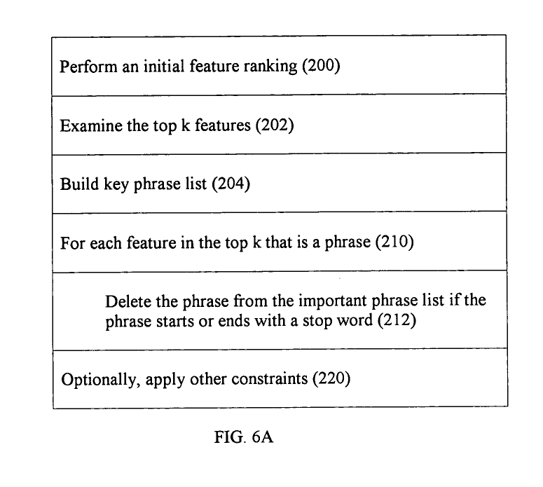

In another aspect of the system, the feature rankings are improved through special consideration of phrases, their component words and acronyms. Phrases influence the frequency counts of its component words. For example, “computer science” documents contains phrases such as “computer programming”, “computer languages.” All three phrases add to the count of “computer” and causes shift in the statistical significance from the phrase to the component feature. To compensate for this shift, an exemplary process to perform phrasal compensation is shown in FIG. 5.

During initial set-up, the process of FIG. 5 builds a collection histogram for reference (104). Next, for each category application, the process builds a positive set histogram (110). Although the building of a histogram can be done using a number of methods, in one embodiment, document vectors are constructed from a text corpus, and the document vectors are added (with a maximum count of once per feature) to form the set histogram. The document vector is a mapping of a feature to a count. To illustrate, if the corpus text is: “I am a computer science student, and I study computer programming in a computer science laboratory environment,” the document vector for feature “computer” would map to count 3 since “computer” occurred three times in the corpus. The remaining document vectors for the exemplary corpus might look like:
computer→3
computer science→2
computer science laboratory″→1
science laboratory→1,
laboratory→1
science→2

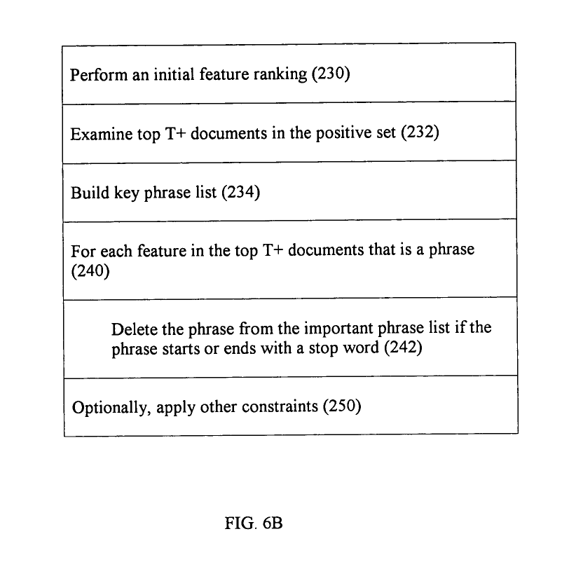

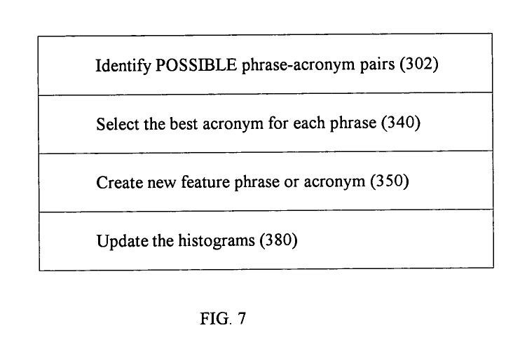

All phrases and words are always included in the set histograms. A new set is selected to be used in a subsequent pass to modify other features in the histogram. Thus, phrasal compensation can be performed by determining “key phrases” or “selected phrases” (112). The determination of key phrases is discussed in more detail in FIGS. 6A-6B below. Next, a list of key phrases is built which decide what other features are to be counted differently (114). The process for updating the positive set histogram is discussed in more detail in FIG. 7.

The process applies the updated histogram for subsequent use (116), for example for use in a ranking method in response to a search query, or for local hierarchy generation as discussed in co-pending, commonly-assigned U.S. application Ser. No. 10/209,594, entitled “INFERRING HIERARCHICAL DESCRIPTIONS OF A SET OF DOCUMENTS”, filed on Mar. 31, 2002, the contents of which are hereby incorporated by reference herein. Thus, the updated histograms can be used in discovering a local topic hierarchy from a set of initial documents, the topic hierarchy containing “parent”, “self’ and “child”0 concepts and to statistically determine the terms used to describe the parents, self and child of a given category. These techniques can be utilized to find the list of features that describe the child terms associated with the given search results.

Turning now to FIGS. 6A-6B, exemplary processes for determining key phrases are shown. These processes find (possibly) important phrases and edit the set by removing those which are not valid and update the counts of those which remain. FIGS. 6A and 6B vary in how each finds the set of possibly important phrases, and what rules determine which ones to keep or remove.

FIG. 6A shows a first exemplary method for determining the key phrases. First, the process perform an initial feature ranking (200). In one implementation, the feature ranking can be based on expected entropy loss as described in co-pending U.S. application Ser. No. 10/371,814, filed Feb. 21, 2003, entitled “Using Web Structures for Classifying and Describing Web Pages”, the content of which is incorporated by reference.

Next, the process of FIG. 6A examines the top k features such as the top 200 features, although other numbers could be used (202). The process then builds a key phrase list (204). For each feature in the top k that is a phrase (for example features that contain more than one term), the process executes loop 210. In loop 210, the process deletes a phrase from the important phrase list if it begins or ends with a stop word (212). Thus, the process skips the phrase if the phrase starts or ends with a stop word (optional)—i.e. “of biology” is skipped, but “biology is fun” is not skipped. Upon completion of loop 210, the process can optionally apply other constraints, such as application of a natural language rule or other textual constraint to the key phrases (220).

Alternatively, a second method for determining key phrases is illustrated in FIG. 6B. The difference between FIG. 6A and 6B is that in FIG. 6A, the original list includes phrases that are in the top k. In FIG. 6B, the list contains all phrases that occur in more than T+ documents in the positive set. Hence, for each feature in the positive set histogram that is a phrase, the process skips the phrase if the phrase starts or ends with a stop word. Next, for the remaining phrases, if the phrase occurs in more than T+ documents in the positive set, the phrase is added to the key phrase list. T+ is a positive set threshold, and in one embodiment, T+ value of 5% of the positive set can be used.

First, the process of FIG. 6B performs an initial feature ranking (230) as described above. Next, the process of FIG. 6B examines the top T+ documents in the positive set (232). The process then builds a key phrase list (234). In loop 240, for each feature in the top T+ documents that is a phrase, the process deletes a phrase from the important phrase list if it begins or ends with a stop word (242). Thus, the process skips the phrase if the phrase starts or ends with a stop word (optional). The process can optionally apply other constraints, such as application of a natural language rule or other textual constraint to the key phrases (250).

A number of methods can be used for histogram updating. In one embodiment which can be slow, but most accurate, the process rebuilds the positive set histogram, but considers the “key phrase” list as atomic features, not permitting them to be broken down. For example, in the exemplary sentence: “I am a computer science student, and I study computer programming in a computer science laboratory environment,” if the key phrase list were blank, then the term “computer” occurs three times, and the phrase “computer science” occurs twice. If the key phrase list included “computer science” and “computer science laboratory”, then the term “computer” is only counted once, since the times computer occurs as part of a key phrase are discounted. Likewise, “computer science” only counts once, since the second time it appears in the sentence is part of a key phrase “computer science laboratory”.

The above method regenerates the document vectors by reprocessing each positive document. In some cases, the reprocessing of documents can be computationally expensive. As an alternate approach, to avoid reprocessing, the original document vectors can be saved, and re-used as described below.

In an alternative method to update the histogram, the positive set document vectors are cached for a performance boost. In this alternative, the process sorts the features in the key-phrase list in order by number of terms, with the largest number of terms first. For each key phrase P, the process obtains the current count Pc from the histogram. For each component term or phrase from the key phrase, the process subtracts Pc.

For example: Using the example document vector described above if the key phrases were “computer science laboratory” and “computer science”, the key phrase “computer science laboratory” has a count of 1. The component terms and phrases are all sub-phrases (and single terms) in this example includes computer, computer science, science, science laboratory, laboratory. The process then subtracts 1 from each count for an updated document vector of:
computer→2
computer science→1
computer science laboratory→1
science laboratory→0
laboratory→0

Then the process continues to the next key phrase “computer science”, and subtracts 1 (the updated number) from the terms “computer” and “science”. The positive set histogram can be built by adding a count of one for each present feature (with a count greater than zero)—in this case the features “laboratory” and “science” are effectively removed.

The advantage of this method is that it is not necessary to reprocess every positive document, only their pre-processed vectors. The disadvantage is that if a term occurs as part of multiple key-phrases (but in different places in them) the counts could go negative. To adjust for this, a count of less than zero is treated as zero.

An example is if the key phrases included “computer science laboratory” and “laboratory environment”, then “laboratory” might end up with a negative count—since it is discounted from both of these phrases, even though it actually only occurred once in the original text.

In yet another embodiment, the process rescans the negative set to compensate for the phrases. If a phrase is deemed significant for a specific community only, then it is likely to be rare in the collection as a whole, and the actual numerical difference in the negative set is likely to be small. If very few phrases are common in large collections, an entropy constraint can be applied before selecting a phrase for correction. Alternatively, commonly occurring phrases for the negative set can be preprocessed and act as an initial key-phrase list. Hence, if the system were looking at a category called “artificial intelligence” which is a subset of “computer science” and the phrase “computer science” was common for the whole collection (in addition to the specific sub category) the negative set histogram could be updated prior to processing—and the key phrase list will always contain “computer science”.

Pseudo-code for one embodiment of the phrasal compensation system is as follows:

```
    identify phrases to be used for compensation
        choose top ranked phrases by expected entropy loss
        ignore phrases that start or end with stop words
    for each document in the positive collection do:
        for each important phrase do
            f_{comp} = f_{comp} − fphr
        for each document component
            If (f_{comp} <= 0) then p_{comp} = p_{comp} − 1
    estimate the expected entropy loss using updated positive frequency
    counts
where f_{comp =} frequency of the component term in the document
    fₚₕᵣ = frequency of the phrase in the document
    p_{comp} = frequency (total document count) of the component term in
    the positive collection
```

Acronym detection

Phrasal compensation can improve feature ranking by compensating for statistical anomalies due to overcounting of component terms. A second problem with determining a human understandable name is when multiple features should be grouped. For example, calling the “computer science” community “computer science or CS” is better than “computer science” alone. CS is an acronym for “computer science”.

FIG. 7 shows an exemplary method that efficiently discovers acronym relations (category specific) and quickly determines the updated statistics for these new features without requiring rescanning the positive and negative sets. At a high level, the process of FIG. 7 identifies potential phrase-acronym pairs (302). Next, the process of FIG. 7 selects the best acronym for each phrase (340), creates new feature phrase or acronym (350), and updates the histograms with the phrase-acronym pairs (380).

In acronym discovery operation 302, multiple phrases are matched to a given acronym as follows:

```
(W₁ W_{2 ...}Wₙ₋₁ Wₙ ) => (L1_{w1} L1_{w2} L1_{w3 ...} L1_{wn} )
    phrase  acronym
where Wₙ = nth word of a phrase
    L1_{wn} = first letter of n^{th} word
```

In one embodiment of step 350 to select the best acronym for a given phrase, the most appropriate acronym match is the one with the highest frequency in the positive set. The system then introduces an “OR” feature of the form (phrase ∥ acronym) e.g. (artificial intelligence ∥ ai) in step 350 of FIG. 7.

In operation 380 to update histograms for the OR features, the positive and negative frequencies of the new feature (phrase ∥ acronym) are determined. The positive frequency can be computed by rescanning raw document data. However, the negative frequency can be computationally expensive to rescan. One approach is to use information from the positive set such as nₚₕᵣ, n_{acro} and results from the positive set. Based the information, one embodiment predicts (nₚₕᵣ U n_{acro})

First, the embodiment computes the co-occurrence probability for each acronym phrase pair, i.e. (pₚₕᵣ ∩ p_{acro}). The probability of occurrence of OR features in the positive set can be computed as follows
(pₚₕᵣ ∩ p_{acro})=pₚₕᵣ+p_{acro}−(pₚₕᵣ ∩ p_{acro}).
Also, from the positive set:
p_{acro/phr}=(pₚₕᵣ ∩ p_{acro})/pₚₕᵣ
where p_{acro}=Probability of the acronym occurring in the positive collection
pₚₕᵣ=Probability of the phrase occurring in the positive collection

To simplify computations, we assume that the probability p_{acro/phr}=remains constant for all documents in both the positive and negative set and n_{acro/phr}=p_{acro/phr}. The probability of occurrence of the OR features in the negative set is then determined as follows:
(nₚₕᵣ ∩ n_{acro})=nₚₕᵣ+n_{acro}−(nₚₕᵣ*n_{acro/phr}).
where n_{acro}=Probability of the acronym occurring in the negative collection
nₚₕᵣ=Probability of the phrase occurring in the negative collection

During the identifying potential phrase-acronym pairs (302), in one implementation, the process builds a hash structure where the key is an acronym, and the value is a list of possibly matching phrases. Next, for each feature, if it could be a possible acronym, insert it into the hash, with the list it points to initialized as blank. In one embodiment, case insensitive features may be used so “CS” and “cs” are not distinguishable. In another embodiment, a case-sensitive approach is used. After the possible acronyms are inserted (the lists are initialized as blank), for each feature that is a phrase, check if the possible acronym (or acronyms) is defined in the hash (308). If the possible acronym is defined, then add that phrase to the list (310). For example: “atm” may be an acronym, so it is added to the list. Later, when “automatic teller machine” is encountered, this phrase is added to the list for “atm”. However, if the process of FIG. 3 encounters “computer science” but “cs” is undefined, then no entry for “cs” is made.

During the selection of the best acronym for each phrase (340), after the lists have been populated, then for each list the best phrase is chosen. In one embodiment, the phrase with the highest positive set frequency is chosen. Thus, if the list includes “computer science” and “cognitive science”, the phrase that occurs in the greatest number of positive documents (which depends on the positive set) is selected. For each acronym, the best phrase is selected (if one exists). Next, the process adds a new feature: phrase acronym. For example, an exemplary entry may be “computer science ∥ cs” or “automatic teller machine ∥ atm”.

During the updating of the histograms (380), one embodiment rescans every document and includes the new logical features. The new logical features represent an OR, so if either component (the phrase or the acronym) is present the whole feature is present. Since the original document vectors probably do not consider co-occurrence, it may not be possible to re-use the previously computed document vectors. Hence, this embodiment can be quite expensive in terms of computational and time costs.

In another embodiment, Bayes rule is used to estimate the new values. The probability of the acronym occurring given that the phrase is present is assumed to be constant for all documents. Given this is constant, the probability can be computed from the positive set, and then used to adjust the negative set, without rescanning all documents. The positive set, which is typically much smaller than the collection or negative set, is rescanned. When rescanning the value for each new logical-OR feature is determined and the probability of the acronym occurring given that the phrase is also computed. Using Bayes rule, the following equation (discussed above) is computed
(nₚₕᵣ U n_{acro})=nₚₕᵣ+n_{acro}−(nₚₕᵣ*n_{acro/phr}).
where nₚₕᵣ is the probability of the phrase occurring in a random document from the negative set (or the negative set frequency), n_{acro} is the probability of the acronym occurring in a random document from the negative set (negative set frequency of the acronym), n_{acro/phr} is the probability of the acronym occurring given the phrase occurred in the negative set—which from the assumption above is the same as p_{acro/phr}, which is computed from rescanning the positive set. The resulting compute (nₚₕᵣ U n_{acro}) is the same as the frequency of the new logical or feature PHRASE ∥ ACRONYM without having to rescan the negative set or the collection set.

The phrasal compensation and the acronym extension improve the quality of the top ranked features. To illustrate, the feature list before and after for an exemplary artificial intelligence corpus is shown below.

| Before | After |
|---|---|
| Artificial | artificial intelligence ∥ ai |
| Intelligence | systems |
| Systems | ai |
| ai | artificial intelligence |
| artificial intelligence | computer science ∥ cs |
| computational | research |
| neural | computational |

Thus, a search for “artificial intelligence” or “ai” will return better results given the enhanced feature list. In addition to phrasal compensation and acronym extension, it is contemplated that synonyms and other information from a thesaurus can be used to promote certain features. Additionally, negative probabilities for the OR features can be computed. The resulting improved feature list can be used in automatic naming and hierarchy discovery.

The present invention is applicable to a wide range of uses including, without limitation, any search engine, information retrieval system, or text analysis system that performs document ranking. Embodiments of the present invention can be readily implemented, for example, into a search engine such as the architecture disclosed in U.S. Utility patent application Ser. No. 10/404,939, entitled “METASEARCH ENGINE ARCHITECTURE,” filed on Apr. 1, 2003, the contents of which are incorporated by reference herein. A result processor module can be readily developed that supplements the feature list with phrases and acronyms and identifies and ranks the documents based on the enhanced feature list.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

1. A method for updating histogram statistics of keyword features, comprising:
building a positive set histogram;
selecting phrases from the positive set histogram; and
modifying the frequency statistics in the histogram using the selected phrases.

2. The method of claim 1, wherein building the positive set histogram comprises:
a. generating a document vector; and
b. adding the document vector to the set histogram.

3. The method of claim 2, wherein the document vector comprises a feature and an occurrence count for the feature.

4. The method of claim 2, wherein the feature is a word or a phrase.

5. The method of claim 1, wherein the selecting phrases comprises:
a. ranking the histogram features; and
b. selecting one or more phrases from the ranked histogram features.

6. The method of claim 5, comprising examining only a preselected number of features from the initial feature ranking.

7. The method of claim 6, wherein phrases are not selected if the phrase starts or ends with a stop word.

8. The method of claim 1, wherein the selecting phrases comprises adding a phrase to a phrase list if the phrase occurs in a specified number of documents.

9. The method of claim 8, wherein phrases are not added if the phrase starts or ends with a stop word.

10. The method of claim 1, comprising rebuilding the positive set histogram by treating the selected phrases as atomic entities.

11. The method of claim 1, wherein updating of the positive set histogram comprises adjusting a count of component words of selected phrases for one or more document vectors.

12. The method of claim 11, for a document vector, comprising:
a. determining a phrase occurrence count and each occurrence count for each word and each consecutive word combination in the phrase; and
b. for each word and word combination in the phrase, subtracting the phrase occurrence count from each occurrence count of each word and each word component in the phrase.

13. The method of claim 12, comprising sorting the selected phrases by the number of words in each phrase.

14. The method of claim 1, comprising:
identifying one or more potential phrase-acronym pairs;
selecting one or more phrase-acronym pairs from the potential pairs; and
creating an “OR” feature of the form (phrase ∥ acronym).

15. A system for updating feature counts, comprising:
means for building a positive set histogram;
means for selecting phrases from the positive set; and
means for modifying the frequency statistics in the histogram using the selected phrases.

16. The system of claim 15, comprising:
means for identifying one or more potential phrase-acronym pairs;
means for selecting a best phrase-acronym pair from the potential pairs; and
means for creating an “OR” feature of the form (phrase ∥ acronym).

17. The system of claim 15, wherein the histogram is modified using:
(nₚₕᵣ U n_{acro})=nₚₕᵣ+n_{acro}−(nₚₕᵣ*n_{acro/phr}).
where nₚₕᵣ is the probability of the phrase occurring in a random document from a negative set, n_{acro} is the probability of the acronym occurring in a random document from the negative set, n_{acro/phr} is the probability of the acronym occurring given the phrase occurred in the negative set.

18. A method for updating histogram statistics of keyword features, comprising:
identifying one or more potential phrase-acronym pairs;
selecting a subset of phrase-acronym pairs from the potential pairs; and
adding a new feature for each selected phrase-acronym (phrase ∥ acronym) pair to a positive set histogram; and
determining a value for each new feature.

19. The method of claim 18, wherein one or more phrases are matched to an acronym as follows:
(W₁ W₂ . . . Wₙ₋₁ Wₙ) [symbol] (L1_{w1} L1_{w2} . . . L1_{w(n-1)} L1_{wn})
where Wₙ=nth word of a phrase
L1_{wn}=first letter of n^{th} word

20. The method of claim 18, wherein phrase-acronym pairs are selected based on the frequency in the positive set histogram.

21. The method of claim 18, wherein the histogram is updated by rescanning each document for an occurrence of an added “OR” feature.

22. The method of claim 18, wherein the histogram is updated using Bayes rule.

23. The method of claim 18, wherein the negative histogram is updated using:
(nₚₕᵣ U n_{acro})=nₚₕᵣ₊ₙ_{acro}−(nₚₕᵣ*n_{acro/phr}).
where nₚₕᵣ is the probability of the phrase occurring in a random document from a negative set, n_{acro} is the probability of the acronym occurring in a random document from the negative set, n_{acro/phr} is the probability of the acronym occurring given the phrase occurred in the negative set.

24. The method of claim 23, wherein n_{acro/phr} equals p_{acro/phr} computed from rescanning a positive set.

25. A method for analyzing a set of documents, comprising:
identifying one or more child concepts;
grouping the one or more child concepts; and
determining a child concept group coverage for one or more documents.

26. The method of claim 25, comprising using the child concept group coverage to compute a generality score.

27. The method of claim 25, wherein a subset of a positive set is used for analyzing the documents.

28. The method of claim 25, comprising selecting a child concept based on frequency of features in a positive set histogram and a collection set histogram.

29. The method of claim 25, comprising selecting one or more features as a representative name for the child concept based on frequency of features in a positive set histogram and a collection set histogram.

30. The method of claim 25, comprising performing agglomerative hierarchical clustering.

31. The method of claim 25, comprising determining a feature's similarity to other feature based on document co-occurrence.

32. The method of claim 25, comprising determining similarity score among child concepts.

33. The method of claim 25, comprising grouping features based on a similarity score.

34. The method of claim 25, comprising taking a cosine of vectors associated with each feature.

35. The method of claim 34, comprising determining
Cosine similarity (Ci,Cj)=|X intersection Y|/sqrt(|X|*|Y|)
where X=Boolean vector associated with child concept Ci
Y=Boolean vector associated with child concept Cj
Xk=1 if Ci is present in document k, and
Xk=0 if Ci is not present in document k.

36. The method of claim 25, comprising ranking clusters based on popularity of members in positive and collection set histograms.

37. The method of claim 36, wherein the ranking comprises:
$$GroupRank = \frac{1}{n} {\sum }_{i = 1}^{n} ( {F}_{i}^{+} * ( {F}_{i}^{-} + ɛ ) )$$
where F⁺ is the positive set frequency, F⁻ is the negative set frequency, n is the number of concepts in the group, and epsilon is a small constant.

38. The method of claim 25, comprising computing a negative relevance score.

39. The method of claim 38, comprising removing documents based on the negative relevance score.

40. The method of claim 38, where the negative relevance score is based on child group coverage score.

41. The method of claim 38, wherein a document is given a low negative relevance score if it does not address a primary theme of the topic.

42. The method of claim 25, wherein the determining of the child concept groups comprises applying phrasal compensation.

43. The method of claim 25, comprising updating histogram statistics of keyword features prior to selecting child concepts.

44. The method of claim 43, comprising:
building a positive set histogram;
selecting phrases from the positive set histogram; and
modifying the frequency statistics in the histogram using the selected phrases.

45. A method for analyzing a set of documents, comprising:
updating histogram statistics of keyword features, including:
building a positive set histogram;
selecting phrases from the positive set histogram; and
modifying the frequency statistics in the histogram using the selected phrases; and
identifying one or more child concepts;
grouping the one or more child concepts;
determining a child concept group coverage for one or more documents.

46. A method for analyzing a set of documents, comprising:
building a positive set histogram;
selecting phrases from the positive set histogram;
modifying the frequency statistics in the histogram using the selected phrases;
identifying one or more potential phrase-acronym pairs;
selecting a subset of phrase-acronym pairs from the potential pairs;
adding a new feature for each selected phrase-acronym (phrase ∥ acronym) pair to a positive set histogram;
determining a value for each new feature;
identifying one or more child concepts based on an updated histogram;
grouping the one or more child concepts; and
determining a child concept group coverage for one or more documents.

47. A method for analyzing a document, comprising:
updating histogram statistics of keyword features, including:
building a positive set histogram;
selecting phrases from the positive set histogram; and
modifying the frequency statistics in the histogram using the selected phrases;
identifying one or more child concepts;
grouping the one or more child concepts; and
determining a child concept group coverage for one or more documents.
